(19) United States
(12) Patent Application Publication
(10) Pub. No.: US 2017/0293991 A1
(43) Pub. Date: Oct. 12, 2017

(54) SYSTEMS AND METHODS FOR DRONE DISPATCH AND OPERATION

(71) Applicant: Wal-Mart Stores, Inc., Bentonville, AR (US)

(72) Inventors: Donald High, Noel, MO (US); Nathan Glenn Jones, Bentonville, AR (US); Gregory Hicks, Bentonville, AR (US)

(21) Appl. No.: 15/482,147

(22) Filed: Apr. 7, 2017

Related U.S. Application Data
(60) Provisional application No. 62/320,090, filed on Apr. 8, 2016.

(51) Int. Cl. G06Q 50/28; G06Q 30/06; G06K 9/00; G01G 23/365; G01G 19/387; B64C 39/02; G05D 1/00

(52) U.S. Cl. CPC G06Q 50/28; B64C 39/02; G06Q 30/0635; G05D 1/0011; G01G 23/365; G01G 19/387; G06K 9/0063; B64C 2201/128; B64C 2201/145

(57) ABSTRACT

Described are systems, methods, and computer readable medium for drone dispatch and operation. Exemplary embodiments provide a group of drones, a server in communication with the drones, and a detachable basket coupled to a shopping cart including an optical machine-readable label that represents identifying data for the basket. The identifying data for the basket is received from a client device at a server. The basket is associated with a user profile corresponding to the client device. Information identifying a vehicle associated with the user profile is determined. A checkout message is received indicating that a user of the client device completed a purchase transaction and requested a drone for transporting the basket. In response to the checkout message, identifying data for the basket is transmitted to a selected drone in the group of drones, and instructions to carry the basket to the vehicle are also transmitted to the selected drone.

### RELATED APPLICATION

This application claims priority to U.S. Provisional Patent Application No. 62/320,090 filed on Apr. 8, 2016, which is hereby incorporated by reference in its entirety.

### BACKGROUND

Drones are robotic devices that may function autonomously without direct user control or alternatively may be directly controlled by users. Drones may be aerial vehicles, land-based vehicles and/or may function in underwater environments. Drones may operate and navigate autonomously. As such, drones can be used and are being used to automate certain activities typically performed by humans. Drones can be used to carry or transport items.

### BRIEF SUMMARY

In one embodiment a drone system for transporting items includes multiple drones, a server in communication with the multiple drones, and a detachable basket coupled to a shopping cart. The basket includes an optical machine-readable label that represents identifying data for the basket. The server includes a profile module and a dispatch module. The profile module is configured to receive the identifying data for the basket from a client device, and associate the basket with a user profile corresponding to the client device. The profile module is also configured to determine information identifying a vehicle associated with the user profile. The dispatch module is configured to receive a checkout message indicating that a user of the client device has completed a purchase transaction and is requesting a drone for transporting the basket. In response to receiving the checkout message, the dispatch module is configured to transmit the identifying data to a selected drone among the multiple drones, and transmit instructions to the selected drone to carry the basket to the vehicle associated with the user profile.

In another embodiment, a method for drone dispatch includes receiving from a client device at a server, identifying data for a basket detachably coupled to a shopping cart. The identifying data is scanned from an optical machine-readable label affixed to the basket. The method further includes associating the basket with a user profile corresponding to the client device, and determining information identifying a vehicle associated with the user profile. The method also includes receiving a checkout message indicating that a user of the client device has completed a purchase transaction and is requesting a drone for transporting the basket. In response to receiving the checkout message, the method includes transmitting the identifying data for the basket to a selected drone among multiple drones, and transmitting instructions to the selected drone to carry the basket to the vehicle associated with the user profile.

In yet another embodiment, a non-transitory computer readable medium stores instructions that when executed by a processor causes the processor to implement a method for dispatching a drone. The method includes receiving from a client device at a server, identifying data for a basket detachably coupled to a shopping cart. The identifying data is scanned from an optical machine-readable label affixed to the basket. The method further includes associating the basket with a user profile corresponding to the client device, and determining information identifying a vehicle associated with the user profile. The method also includes receiving a checkout message indicating that a user of the client device has completed a purchase transaction and is requesting a drone for transporting the basket. In response to receiving the checkout message, the method includes transmitting the identifying data for the basket to a selected drone among multiple drones, and transmitting instructions to the selected drone to carry the basket to the vehicle associated with the user profile.

### BRIEF DESCRIPTION OF DRAWINGS

The accompanying drawings, which are incorporated in and constitute a part of this specification, illustrate one or more embodiments of the invention and, together with the description, help to explain the invention. The embodiments are illustrated by way of example and should not be construed to limit the present disclosure. In the drawings:

FIG. 1 illustrates a network diagram depicting a system for implementing a drone dispatch system, according to an example embodiment;

FIG. 2 is a block diagram showing the drone dispatch system implemented in modules, according to an example embodiment;

FIG. 3 is a flowchart showing an exemplary method for dispatching a drone, according to an example embodiment;

FIG. 4 schematically depicts an exemplary cart for use with the drone dispatch system, according to an example embodiment; and

FIG. 5 is a block diagram of an exemplary computing device that can be used to implement exemplary embodiments of the drone dispatch system described herein.

### DESCRIPTION OF EXEMPLARY EMBODIMENTS

Described in detail herein are systems, methods, and computer readable medium for a drone dispatch and operation system. Exemplary embodiments provide for dispatching a drone to aid in carrying items purchased by a user from the retail store to the user' vehicle. The role of the traditional “bag boy/girl” that used to carry out groceries to a customer's car is not as prevalent as it used to be. Nowadays, customers carry their own merchandise to their cars, which can be cumbersome or inconvenient, especially for elderly customer or customers with a disability. However, the former job of the bag boy/girl can be automated with the use of a drone to remove the basket from a shopping cart and fly or drive the merchandise out to the customer's car. The drone can either then deliver the basket of items to the trunk or the truck bed of a customer's vehicle or to a location near the vehicle.

Exemplary embodiments provide for a group of drones in communication with a server, and a shopping cart with a detachable basket that includes a label providing identifying data for the basket. Using the identifying data, the basket is associated with a user profile corresponding to a client device. Information identifying a vehicle may be determined from a previously stored user profile. Once a checkout message indicating that a user has completed a purchase transaction is received by the server, the server transmits instructions to a selected drone to find and carry the basket associated with the user profile to the vehicle determined from the user profile. In this manner, exemplary embodiments provide a mechanism for a customer to request their shopping basket to be delivered to their car after they have checked out of a retail store. Exemplary embodiments include a shopping cart having a detachable basket that the drone can attach to and release once it reaches the customer's vehicle. The customer's vehicle may be any type of car truck, or other vehicle.

In one embodiment a user may install an application (app) on his or her device (client device) which enables recording the parked location of the user's vehicle. At the store, the user may use a specialized shopping cart that is coupled to a detachable basket that a drone can attach to or carry. Before shopping or at the time of checkout, the user can indicate that he or she wants a drone to deliver the purchased items to the vehicle. The notification may be made from the user's mobile device or from a POS terminal in response to a user request. After checkout, the user can leave the basket with the items at a designated drone launch area near or within the retail store. In response to the request a drone is dispatched and attaches to the detachable basket, and flies or drives the merchandise to the location captured earlier via the application on the user's device and provided to the server which included the location in the drone dispatch instructions. The drone dispatch system may use video analytics (image of license plate, etc.) to confirm the customer's vehicle in addition to the recorded location of the vehicle. Once delivered, the user may return the basket to a designated area in the parking lot or near the retail store. Alternatively, the user may take the basket with them and return it at a later time, upon on their next visit to the retail store.

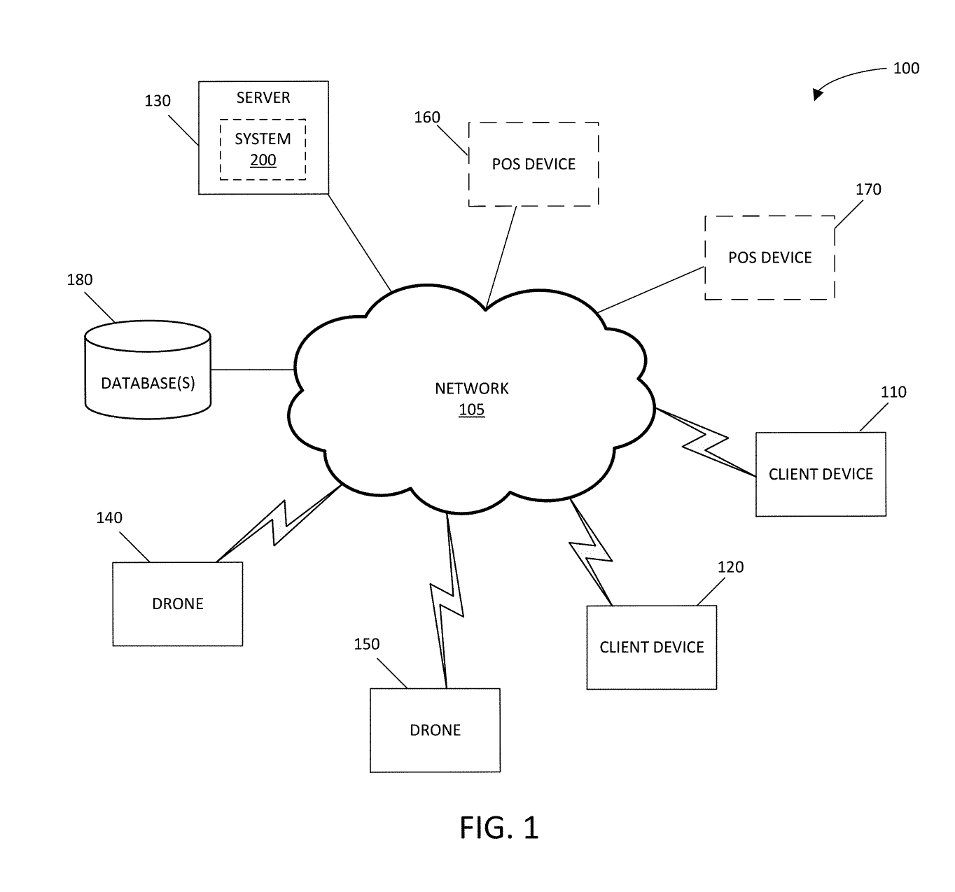

FIG. 1 illustrates a network diagram depicting a system 100 for implementing the drone dispatch system, according to an example embodiment. The system 100 can include a network 105, multiple client devices, for example client device 110 and client device 120, a server 130, multiple drones, for example drone 140 and drone 150 and database(s) 180. The system 100 may also optionally include multiple POS devices, for example POS device 160 and POS device 170. Each of the components 110, 120, 130, 140, 150, 160, 170, and 180 is in communication with the network 105.

In an example embodiment, one or more portions of network 105 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks. The network 105 may be located in, or cover, a large retail facility such as a warehouse club building and its surrounding environment.

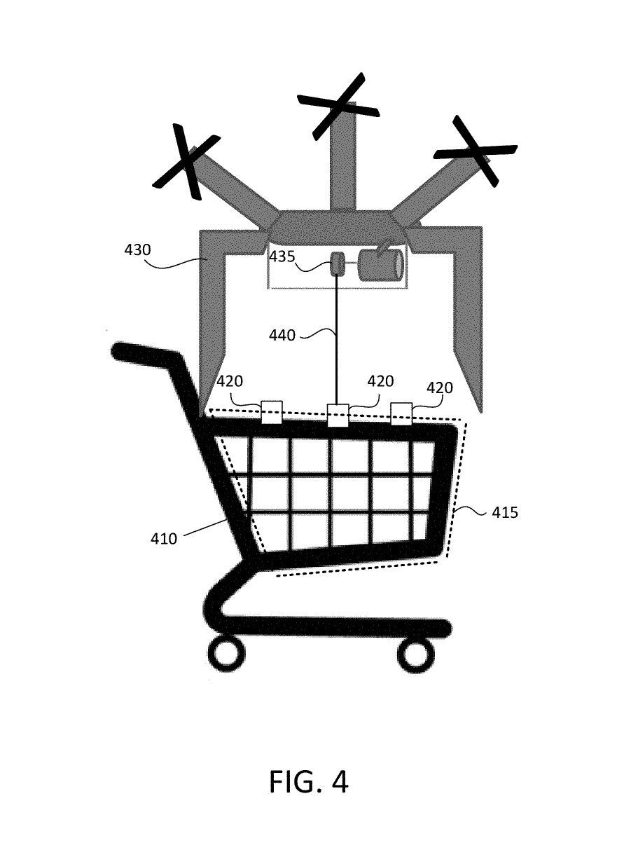

The client device 110, 120 may include, but is not limited to, hand-held devices, wireless devices, portable devices, wearable computers, cellular or mobile phones, portable digital assistants (PDAs), smart phones, tablets, multi-processor systems, microprocessor-based or programmable consumer electronics, mini-computers, and the like. The client device 110, 120 can include one or more components described in relation to computing device 400 shown in FIG. 4. In one embodiment, the client device 110, 120 is a smartphone operated by a customer within a retail store to complete a purchase transaction and/or to request a drone to transport items. The client device 110, 120 may connect to network 105 via a wireless connection. In some embodiments, the client device 110, 120 may connect to the network 105 via a wired connection. In one embodiment client device 110, 120 may connect to network 105 via POS device 160,170. The client device 110, 120 may include one or more applications such as, but not limited to, a checkout transaction application or shopping application provided by a retail store. The client device 110, 120 may also include a drone request application provided by a retail store that enables a user to request a drone according to the drone dispatch system described herein. The client device 110, 120 may further include a global positioning system (GPS) that provides location information of the client device.

The drone 140, 150 may be an unmanned aerial vehicle or unmanned ground vehicle. The drone 140, 150 may be any commercially available or other drone capable of performing the functionalities described herein, including transportation of items. The drone 140, 150 is capable of autonomous flight or navigation, is aware of its surroundings, and is programmable. The drone 140, 150 may also include a processing device or an on-board computing device and memory to store instructions or data. In some embodiments, the drone 140, 150 may be coupled to a carrying hook or frame or similar mechanism that enables the drone to carry items, such as a basket. The drone 140, 150 may also include a wireless communication interface or mechanism to facilitate communications with at least server 130 via network 105. The drone 140, 150 may also include a scanner capable of reading or scanning an optical machine-readable label. In some embodiments, the drone 140, 150 may also include an imaging device to view its surroundings, in particular information for identifying a vehicle, or an imaging device to capture images, audio and/or video of its surroundings.

The POS device 160, 170 may include, but is not limited to, cash registers, work stations, computers, general purpose computers, Internet appliances, hand-held devices, wireless devices, portable devices, wearable computers, cellular or mobile phones, portable digital assistants (PDAs), smartphones, tablets, ultrabooks, netbooks, laptops, desktops, multi-processor systems, microprocessor-based or programmable consumer electronics, game consoles, set-top boxes, network PCs, mini-computers, and the like. The POS device 160, 170 is part of a store infrastructure and aids in performing various transactions related to sales and other aspects of a store. Being part of a store's infrastructure, the POS device 160, 170 may be installed within the store or may be installed or operational outside of the store. The POS device 160, 170 can include one or more components described in relation to computing device 400 shown in FIG. 4.

The POS device 160, 170 may also include various external or peripheral devices to aid in performing sales transactions and other duties. Examples of peripheral devices include, but are not limited to, barcode scanners, cash drawers, monitors, touch-screen monitors, clicking devices (e.g., mouse), input devices (e.g., keyboard), receipt printers, coupon printers, payment terminals, and the like. Examples of payment terminals include, but are not limited to, card readers, pin pads, signature pads, signature pens, Square™ registers, LevelUp™ platform, cash or change deposit devices, cash or change dispensing devices, coupon accepting devices, and the like. The POS device 160, 170 may connect to network 105 via a wired or wireless connection. The device 320 may include one or more applications such as, but not limited to, a sales transaction application.

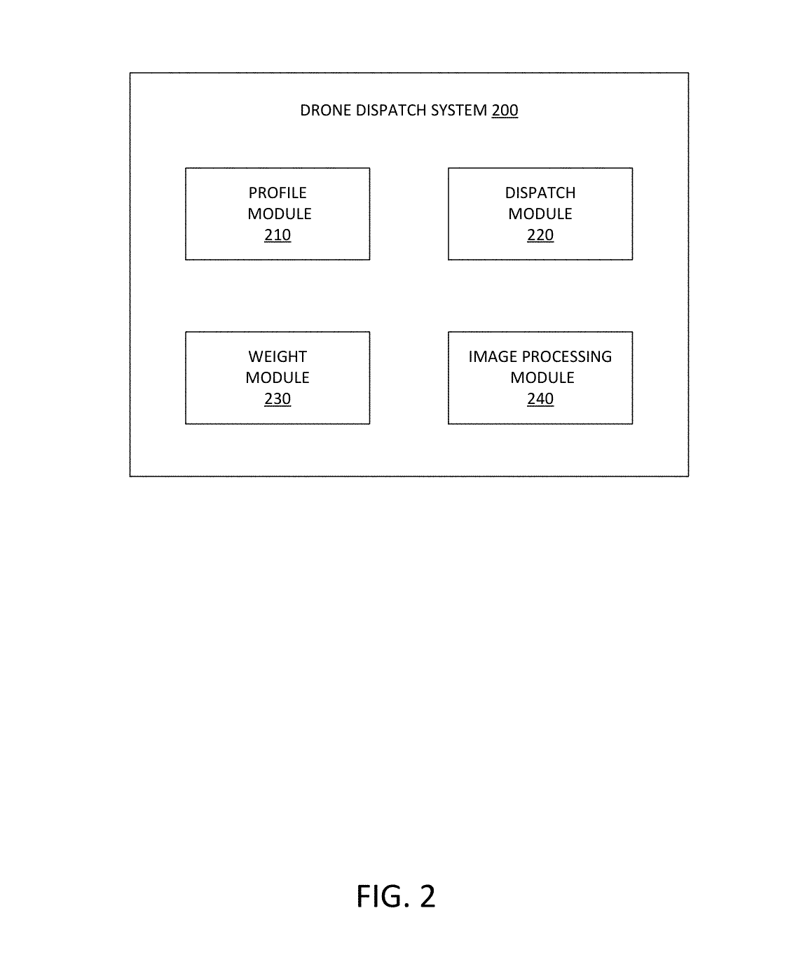

The server 130 includes one or more computers or processors, and memory to store instructions and perform some of the functionalities described herein. The server 130 is configured to communicate, via network 105, with the client device 110, 120, the drone 140, 150, the POS device 160, 170, and database(s) 180 to perform the functionalities of the drone dispatch system as described herein. The server 130 may host one or more applications (for example, a shopping application, checkout transaction application and/or a drone dispatch application based on the drone dispatch system described herein) or websites accessible by the client device 110, 120. Server 130 may also facilitate access to the content of database(s) 180. In an example embodiment, the components of the drone dispatch system 200 shown in FIG. 2 are included in server 130, and the server is configured to receive identifying data for a basket from a client device, associate the basket with a user profile corresponding to the client device, and determine information identifying a vehicle associated with the user profile. The server 130 is also configured to receive a checkout message indicating that a user has completed a purchase transaction and is requesting a drone for transporting the basket. In response server 130 transmits the identifying data for the basket along with instructions for the selected drone to carry the basket to the vehicle.

Drone 140, 150 may be capable of autonomous flight or navigation, and the server 130 may provide flight or navigation instructions to the drone 140, 150 based on the location of the destination vehicle to which the drone is to deliver the basket. In some embodiments, the server 130 may also instruct the drone 140, 150 to return any empty baskets left in designated basket-return areas to a drone launch or pickup area.

In an example embodiment, some of the actions of the drone dispatch system 200 may be performed by the client device 110, 120. For example, the client device 110, 120 may scan an optical machine-readable label, transmit data obtained from scanning the label, perform a checkout transaction and transmit a checkout message to the server. The client device 110, 120 may include a drone request or dispatch application that receives input from a user of the client device 110, 120 related to username, password, user profile information, information related to one or more vehicles, and/or delivery preference. The information related to one or more vehicles may include an image of the vehicle, a license plate number for the vehicle, a make and a model of the vehicle, a type of the vehicle (sedan or truck) and/or a color of the vehicle. The delivery preference indicates the user's preference on where or how the drone should deliver the basket. The received input may be provided to server 130 for storage in a user profile associated with the client device 110, 120.

In some embodiments, the client device 110, 120 may perform a checkout transaction via a checkout application provided by the retail store. For example, the user may be able to scan items that he or she would like to purchase, and when the user is ready to checkout, the checkout application calculates a transaction amount due to complete purchase of the items. The user can pay for the items via the checkout application on the client device 110, 120. When the checkout transaction is completed, the client device 110, 120 via the checkout application transmits a checkout message to the server 130 indicating that the user has completed checkout, and has requested a drone to carry the items to a vehicle. In one embodiment the checkout application may communicate with the POS device 160,170 instead of directly with server 130 in transmitting the checkout message.

Each of the database(s) 180 and server 130 is connected to the network 105 via a wired connection. Alternatively, one or more of the database(s) 180 and server 130 may be connected to the network 105 via a wireless connection. Database(s) 180 include one or more storage devices for storing data and/or instructions (or code) for use by the client device 110, 120, server 130, drone 140, 150, and POS device 160, 170. Database(s) 180, and/or server 130, may be located at one or more geographically distributed locations from each other or from the client device 110, 120. Alternatively, database(s) 180 may be included within server 130.

FIG. 2 is a block diagram showing a drone dispatch system 200 in terms of modules according to an example embodiment. The modules may include profile module 210, a dispatch module 220, a weight module 230, and an image processing module 240. One or more of the modules of system 200 may be implemented in server 130 of FIG. 1. The modules may include various circuits, circuitry and one or more software components, programs, applications, or other units of code base or instructions configured to be executed by one or more processors included in server 130. Although modules 210, 220, 230, and 240 are shown as distinct modules in FIG. 2, it should be understood that modules 210, 220, 230, and 240 may be implemented as fewer or more modules than illustrated. It should be understood that any of modules 210, 220, 230, and 240 may communicate with one or more components included in system 100 (FIG. 1), such as client device 110, 120, drone 140, 150, POS device 160, 170, server 130 or database(s) 180.

The profile module 210 may be configured to manage and maintain data for a user profile for a customer of a retail store who uses the drone dispatch system. For example, the profile module 210 may manage and maintain data such as username, password, vehicle information, location of vehicle, image of a vehicle, delivery preference and the like. The profile module 210 may also receive data identifying a particular basket and associate the basket with a user profile that is associated with the requesting client device.

The dispatch module 220 may be configured to manage and analyze information or data used for dispatching drones. For example, the dispatch module 220 may manage and analyze vehicle information, vehicle location data, checkout completion information, and delivery preference information. The dispatch module 220 is also configured to track the current location and status of the drones available to the system 100. Such information may be provided by the drones 140, 150 to server 130 on an ongoing basis and stored in database 180 for use by the dispatch module 220 as needed. The dispatch module 220 may also be configured to generate and transmit instructions to a drone for carrying a basket of items to a particular vehicle.

The weight module 230 may be configured to receive and analyze a weight of items in a basket, and select a type of drone to carry the basket based on the weight of the items. As discussed further below, the weight of items may be measured by an integrated scale included in the detachable basket and communicated to server 130.

The image processing module 240 may be configured to manage and analyze images of a vehicle to identify a vehicle for basket delivery, and to verify that the drone is delivering the basket to the correct vehicle. The image processing module 240 may receive and process image data stored with respect to a user profile (entered by a user). The image processing module 240 may also receive and process image data obtained by a drone during delivery of a basket.

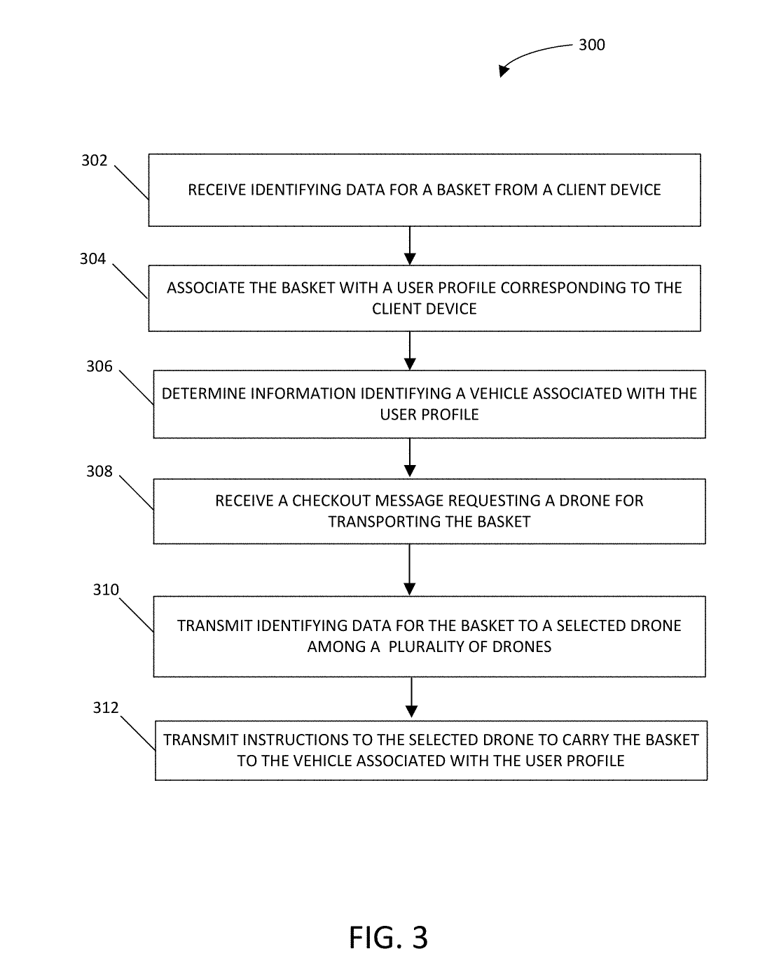

FIG. 3 is a flowchart showing an exemplary method 300 for dispatching a drone, according to an example embodiment. The steps of method 300 may be performed by one or more modules shown in FIG. 2.

At step 302, the profile module 210 on the server 130 receives identifying data for a basket from a client device. The basket is detachably coupled to a shopping cart, and an optical machine-readable label may be affixed to the basket. The optical machine-readable label may be a barcode label, QR label or any other label that when scanned provides data identifying the basket. It will be appreciated that other mechanisms in addition to, or instead of, a label may also be used to identify the basket. The client device 110, 120 may scan the optical machine-readable label and transmit the identifying data to the server 130.

In an example embodiment, the profile module 210 receives location information for a vehicle as recorded by a GPS of the client device 110, 120. When a customer parks his or her vehicle in a parking lot of the retail store, the drone dispatch application on the client device 110, 120 activates the GPS and records the location of the vehicle in the parking lot. The GPS may be activated when the application detects the client device 110, 120 to be in proximity to the retail store. The profile module 210 may receive and store the vehicle location for later use or may receive the vehicle location information at the time of the dispatch module receiving the checkout message request(discussed further below).

At step 304, the profile module 210 associates the basket, based on the identifying data, with a user profile corresponding to the client device 110, 120 that scanned the optical machine-readable label. This association information is later used by the server 130 to instruct a drone to carry the basket associated with the user profile to a vehicle associated with the user profile.

At step 306, the profile module 210 determines information identifying a vehicle associated with the user profile. A user may store information related to one or more vehicles in the user profile. Such information can include license plate number, make and model of the vehicle, color of the vehicle and the like. In some embodiments, the user profile may include an image of the vehicle. In an example embodiment, the profile module 210 determines the location of vehicle via the location information received from the client device 110, 120 and recorded by the GPS of the client device 110, 120.

At step 308, the dispatch module 220 receives a checkout message indicating that a user of the client device completed a purchase transaction and requested a drone for transporting the basket. The checkout message may be generated when the user completes a checkout transaction to purchase the items in the basket at a POS device (such as POS device 160, 170) in the retail store. Alternatively, the user may complete a checkout transaction using an application (app) on his or her client device. For example, the user may scan a barcode on each item that he or she wants to purchase, and the item information and price may be ascertained by the client device. When the user is done shopping, the client device may provide total amount due, and the user may complete checkout by providing payment via the client device and requesting a drone for pickup of the purchases. As noted, in some embodiments, the user may request a drone to carry the basket at the time of checkout. Alternatively, the user may request a drone to carry the basket before he or she starts shopping, in which case the request may be associated with the user profile corresponding to the client device.

At step 310, the dispatch module 220, in response to receiving the checkout message, transmits identifying data for the basket to a selected drone among a group of drones. The group of drones may include aerial drones and ground drones. In some embodiments, the dispatch module 220 may select a drone from the group of drones for carrying the basket. The drone may be selected based on various factors, such as, the weight of the basket, the battery life of the drone, the availability of the drone, the operational characteristics of the drone, and the like. The dispatch module 220 transmits the identifying data for the basket to the selected drone, so that the selected drone may identify the basket that it is instructed to carry. In an example embodiment, after checkout the user leaves the basket at a designated drone launch or pickup area. Once the drone receives the data identifying the basket, the drone may scan the basket(s) in the designated drone launch or pickup area to identify the basket it is instructed to carry. After identifying the basket, the drone latches onto the basket or attaches itself to basket in some other manner. The drone may include any appropriate mechanism, such as hooks (for an aerial drone) or lifts (for a ground drone), to carry the basket.

In an example embodiment, the basket includes an integrated weight to measure the total weight of the items in the basket. The integrated scale may be in direct communication with the server 130 or in indirect communication with the server by communicating through POS device 160, 170 or client device 110, 120. The weight module 230 receives a total weight of items in the basket from the integrated scale and compares the total weight of the items to a predefined threshold. If the total weight is less than the predefined threshold, then the weight module 230 selects an aerial drone to carry the basket. The dispatch module 220 transmits identifying data for the basket and instructions to a selected aerial drone. If the total weight is less than the predefined threshold, then the weight module 230 selects a ground drone to carry the basket. The dispatch module 220 transmits identifying data for the basket and instructions to a selected ground drone.

At step 312, the dispatch module 220 transmits instructions to the selected drone to carry the basket to the vehicle associated with the user profile. The dispatch module 220 may transmit the location of the vehicle, and the drone autonomously navigates to the location of the vehicle to deliver the basket (after first identifying and retrieving the basket). In other embodiments, the dispatch module 220 may determine a route to the vehicle's location from the drone launch or pickup area, and provide directions to navigate the route based on known obstacles and landmarks such as fixtures in the parking lot and around the store and the lanes and parking spaces in the parking lot. The dispatch module 220 may transmit the route and the directions to the drone 140, 150, and the drone may deliver the basket to the vehicle using the route and directions provided by the server 130.

In an example embodiment, the user profile includes a delivery preference for a vehicle. The dispatch module 220 transmits instructions to the drone 140, 150 to deliver the basket according to the delivery preference. The delivery preference may indicate how and where the user wants the basket delivered. For example, if the vehicle is a truck, the user may prefer that the basket is delivered to the truck bed or the rear loading area of the truck. If the vehicle is a sedan, the user may prefer that the basket is delivered in the trunk of the sedan. Alternatively, the user may prefer the basket is delivered on the ground near the vehicle so he/she may place it in the vehicle himself.

In some embodiments, the user may take the basket with him or her and return it on his or her next visit to the retail store. In other embodiments, the user may empty the basket and return the empty basket to a designated basket-return area. The server 130 may instruct a drone 140, 150 to collect the empty baskets from the designated return area, and return them to a launch or pickup area. In some embodiments, as part of the return process the drone may connect the basket to a shopping cart so that future customers may use the shopping cart.

In some examples, the user profile may include information for more than one vehicle used by the user. In one embodiment, the application on the client device 110, 120 prompts the user to select the vehicle he or she is using and the drone will deliver the basket to the selected vehicle. In another embodiment, the drone 140, 150 carries the basket to the location stored by the profile module 210, takes an image or views the vehicle at the location, and checks the vehicle information against the information for multiple vehicles stored in the user profile. If the vehicle observed by the drone 140, 150 matches any one of the vehicles stored in the user profile, the drone delivers the basket. The drone 140, 150 may verify the vehicle by analyzing a make and a model of the vehicle, a color of the vehicle, or a license plate number of the vehicle.

In some embodiments, the user may provide a code (alphanumerical code) as part of his or her user profile. The code may allow the drone to automatically open the trunk of the vehicle. For example, the vehicle may be equipped with Bluetooth or wifi connectivity and may be able to receive communications from the drone or other devices. The drone may transmit the code to the vehicle to open the trunk of the vehicle.

FIG. 4 schematically depicts an exemplary shopping cart 410 for use with the drone dispatch system, according to an example embodiment. Shopping cart 410 may be used where an aerial drone, for example, drone 430, is used to carry items to a user's vehicle. The cart 410 includes a detachable basket 415. The drone 430 may be drone 140 or drone 150 of FIG. 1, and may be capable of performing the functionalities described with respect to drones 140, 150.

In some embodiments, the cart 410 is made of metal, while the detachable basket 415 is made of a lightweight material so that the drone 430 is capable of carrying the basket 415 with items in it. For example, the basket 415 may be made of carbon fiber, plastic, or other lightweight material. The basket 415 includes one or more hooks 420 or connection points 420 at a top rim of the basket 415 for the drone 430 to latch or attach to the basket 415, and carry the basket 415. In some embodiments, the hooks or connection points 420 are metal hooks or loops. In other embodiments, the hooks or connection points 420 are flat metal plates to which drone 430 may attach electromagnetically.

The drone 430 includes a crane 435 with a spool of wire 440 or other type of cable material. The end of wire 440 includes a hook or connection point that corresponds to the hooks or connection points 420 on the basket 415. The drone 430 unspools the wire 440 from the crane 435 to lower the corresponding hook or connection point to connect or attach to the basket 415 via one or more hooks 420 on the basket 415. For example, if the hooks 420 are hooks, then the corresponding hook on the wire 440 is a hook that is capable of hooking or attaching to the hooks 420. If the connection points 420 is a metal plate, then the corresponding connection point on the wire 440 is an electromagnet capable of latching or attaching to the metal plate connection points 420.

In an example embodiment, the crane 435 is capable of lowering multiple hook or connection points to securely latch or attach to the basket 415. After the drone 430 latches or attaches to the basket 415, the crane 435 pulls up the basket 415 to secure it with the drone 430. In another embodiment, the drone may land on or hover immediately adjacent to the basket during the connection process with the wire in the spooled (wound) position.

In some embodiments, the drone dispatch system 200 is in communication with the cart 410. When the drone 430 attaches to the basket 415 and is ready to carry the basket 415, the drone dispatch system 200 is configured to transmit an unlock request to the cart 410 to unlock or detach the basket 415 from the cart 410. The cart 410 may transmit an electric or radio signal to one or more controllable locking mechanisms on the cart upon receiving the unlock request from drone 430 so that basket 215 may be removed from the cart.

In some embodiments, the basket 415 includes a mechanism to secure the bags placed in the basket 415. If the bags are made of plastic, there is a risk that when the aerial drone 430 hovers over the basket 415, the plastic bags are blown away or out of the basket 415. In an example embodiment, the basket 415 may include a bag holder mechanism to secure the bags in the basket to prevent them from blowing out of the basket 415. In an example embodiment, the basket 415 may include a lid that can be closed once the bags with items are placed in the basket 415. The lid is configured to secure the bags to prevent them from blowing out of the basket 415 as a result of drone operations. In another embodiment, the user may use linen bags or bags made of other heavy material (than plastic) to avoid the bags from blowing out of the basket 415.

As described above, in some embodiments, the drone 430 is instructed to collect an empty basket 415 and return it to a launch or pickup area. In some embodiments, the drone 430 returns the basket 415 to the shopping cart from which it was detached, for example cart 410. However, in another embodiment, the drone 430 may return the basket 415 to any other shopping cart available in the launch or pickup area. Once the basket 415 is attached to a shopping cart, the drone dispatch system 200 can identify and store a parent-child relationship between the cart and the basket.

In this manner, the drone dispatch system described herein aids in carrying items purchased by a user from the retail store to the user' vehicle. In a non-limiting example, a user parks his or her vehicle in a parking lot of a store or near a store. An application included on the user's mobile device identifies and stores the location of the user's vehicle, for example, using the GPS included in the user's mobile device. The user selects a specialized shopping cart at the store for purchasing items (i.e. a basket equipped with a detachable basket portion suitable for drone pickup). The specialized shopping cart may include a scale to weigh items as the user places them in the basket. In one embodiment, the scale may be integrated into the cart. Based on the total weight of the items placed in the cart, the drone dispatch system chooses between an aerial drone, which has lower weight limitations, and a ground drone to carry the basket with the items to the user's vehicle when a dispatch is requested by the user. When the user is ready, he or she checks out at a POS device in the store or checks out via the application included on the user's mobile device. During the checkout process, the user is prompted to confirm the location of his or her vehicle. For example, the drone dispatch system may prompt the user to confirm that the vehicle is located at the same location as it was at a previous time. During the checkout process, the drone dispatch system also prompts the user to select the delivery method of the items. For example, the user may select between delivery in the vehicle's trunk or beside the vehicle. After completing checkout, the user moves the shopping cart to a designated launch or pickup area. The drone selected by the drone dispatch system attaches to the basket and carries it to the location of the vehicle. The drone may also identify the vehicle for delivery using an imaging sensor based on other information previously provided by the user, such as license plate number, make and model of vehicle, color of vehicle, etc.

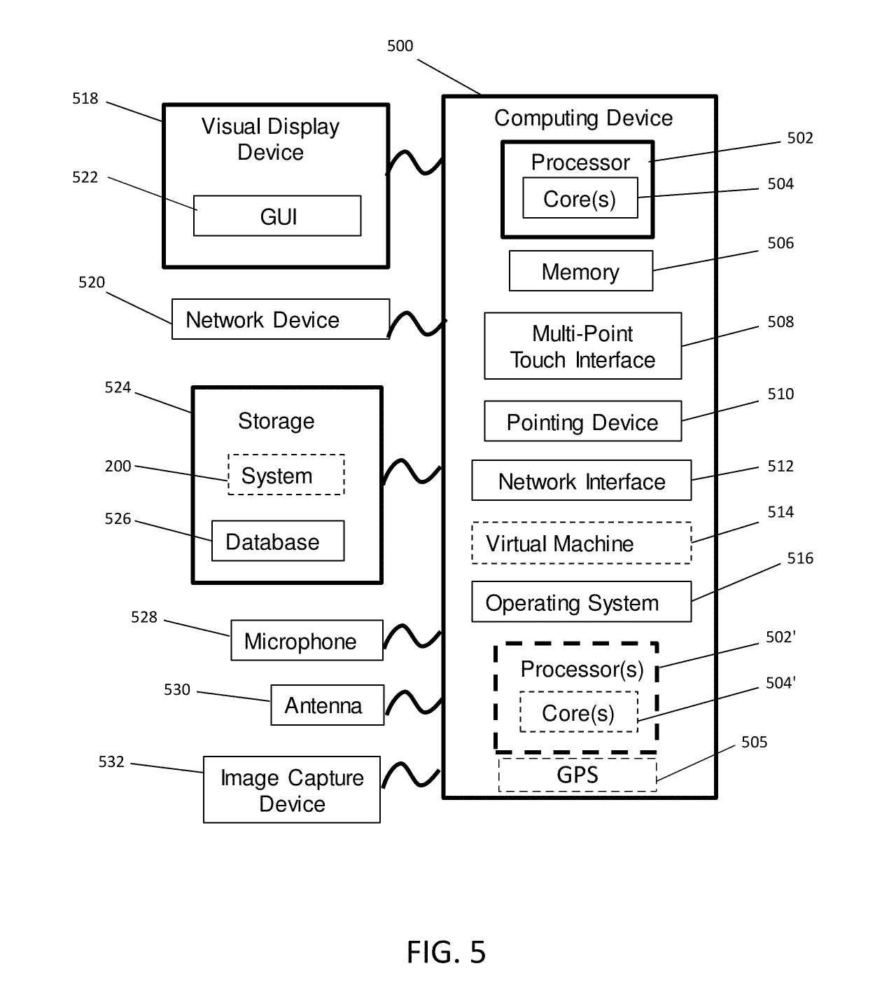

FIG. 5 is a block diagram of an exemplary computing device 500 that may be used to implement exemplary embodiments of the drone dispatch system 200 described herein. The computing device 500 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 506 included in the computing device 500 may store computer-readable and computer-executable instructions or software for implementing exemplary embodiments of the drone dispatch system 200. The computing device 500 also includes configurable and/or programmable processor 502 and associated core 504, and optionally, one or more additional configurable and/or programmable processor(s) 502′ and associated core(s) 504′ (for example, in the case of computer systems having multiple processors/cores), for executing computer-readable and computer-executable instructions or software stored in the memory 506 and other programs for controlling system hardware. Processor 502 and processor(s) 502′ may each be a single core processor or multiple core (504 and 504′) processor.

When the computing device 500 is client device 110,120 as discussed in FIG. 1, computing device 500 may also include a GPS 505 that can determine the location of the computing device 500. The location may be used to determine the location of the user's vehicle for various embodiments of the drone dispatch system described herein.

Virtualization may be employed in the computing device 500 so that infrastructure and resources in the computing device may be shared dynamically. A virtual machine 514 may be provided to handle a process running on multiple processors so that the process appears to be using only one computing resource rather than multiple computing resources. Multiple virtual machines may also be used with one processor.

Memory 506 may include a computer system memory or random access memory, such as DRAM, SRAM, EDO RAM, and the like. Memory 506 may include other types of memory as well, or combinations thereof.

A user may interact with the computing device 500 through a visual display device 518, such as a computer monitor, which may display one or more graphical user interfaces 522 that may be provided in accordance with exemplary embodiments. The computing device 500 may include other I/O devices for receiving input from a user, for example, a keyboard or any suitable multi-point touch interface 508, a pointing device 510 (e.g., a mouse), a microphone 528, and/or an image capturing device 532 (e.g., a camera or scanner). The multi-point touch interface 508 (e.g., keyboard, pin pad, scanner, touch-screen, etc.) and the pointing device 510 (e.g., mouse, stylus pen, etc.) may be coupled to the visual display device 518. The computing device 500 may include other suitable conventional I/O peripherals.

The computing device 500 may also include one or more storage devices 524, such as a hard-drive, CD-ROM, or other computer readable media, for storing data and computer-readable instructions and/or software that implement exemplary embodiments of the drone dispatch system 200 described herein. Exemplary storage device 524 may also store one or more databases for storing any suitable information required to implement exemplary embodiments. For example, exemplary storage device 524 can store one or more databases 526 for storing information, such as user profile information, basket identifying data, vehicle identifying information, transaction information, and/or any other information to be used by embodiments of the system 200. The databases may be updated manually or automatically at any suitable time to add, delete, and/or update one or more items in the databases.

The computing device 500 can include a network interface 512 configured to interface via one or more network devices 520 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing device 500 can include one or more antennas 530 to facilitate wireless communication (e.g., via the network interface) between the computing device 500 and a network. The network interface 512 may include a built-in network adapter, network interface card, PCMCIA network card, card bus network adapter, wireless network adapter, USB network adapter, modem or any other device suitable for interfacing the computing device 500 to any type of network capable of communication and performing the operations described herein. Moreover, the computing device 500 may be any computer system, such as a workstation, desktop computer, server, laptop, handheld computer, tablet computer (e.g., the iPad™ tablet computer), mobile computing or communication device (e.g., the iPhone™ communication device), point-of sale terminal, internal corporate devices, or other form of computing or telecommunications device that is capable of communication and that has sufficient processor power and memory capacity to perform the operations described herein.

The computing device 500 may run any operating system 516, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 516 may be run in native mode or emulated mode. In an exemplary embodiment, the operating system 516 may be run on one or more cloud machine instances.

The following description is presented to enable any person skilled in the art to create and use a computer system configuration and related method and article of manufacture to dispatch and use a drone. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components or steps may be replaced with a single element, component or step Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A drone system for transporting items comprising:
a plurality of drones;
a server in communication with the plurality of drones, the server including a profile module and a dispatch module;
a detachable basket coupled to a shopping cart, the basket including an optical machine-readable label that includes identifying data for the basket;
wherein the profile module is configured to:
receive the identifying data for the basket from a client device,
associate the basket with a user profile corresponding to the client device, and
determine information identifying a vehicle associated with the user profile;
wherein the dispatch module is configured to:
receive a checkout message indicating that a user of the client device completed a purchase transaction and requests a drone for transporting the basket, and
in response to receiving the checkout message, transmit to a selected drone among the plurality of drones the identifying data for the basket and instructions to carry the basket to the vehicle.

2. The drone system of claim 1, wherein the information identifying the vehicle includes a location of the vehicle determined by a GPS of the client device when the vehicle is parked in proximity to a retail store, the location of the vehicle transmitted to the server by the client device and stored by the server.

3. The drone system of claim 2, wherein the instructions transmitted to the selected drone causes the selected drone to locate the basket using the identifying data for the basket, and to carry the basket to the vehicle based on the location of the vehicle stored by the server.

4. The drone system of claim 3, wherein the information identifying the vehicle includes an image of the vehicle stored by the server, and the selected drone is configured to process the image of the vehicle to determine that the vehicle at the location matches the vehicle associated with the user profile.

5. The drone system of claim 1, wherein the information identifying the vehicle includes at least one of a license plate number, a make and a model of the vehicle, and a color of the vehicle.

6. The drone system of claim 1, wherein the basket includes an integrated scale to measure a total weight of items in the basket, the integrated scale in communication with the server.

7. The drone system of claim 6, wherein the plurality of drones includes ground drones and aerial drones, and wherein the dispatch module is further configured to:
receive a total weight of the items in the basket,
compare the total weight with a predefined threshold, and
when the total weight is less than the predefined threshold, transmit instructions to an aerial drone as the selected drone, and
when the total weight is more than the predefined threshold, transmit instructions to a ground drone as the selected drone.

8. The drone system of claim 1, wherein the user profile includes a delivery preference, and the drone delivers the basket according to the delivery preference.

9. The drone system of claim 8 wherein the delivery preference indicates to deliver the basket in the trunk or rear of the vehicle.

10. The drone system of claim 8 wherein the delivery preference indicates to deliver the basket on the ground near the vehicle.

11. A method for drone dispatch, the method comprising:
receiving, from the client device at a server, identifying data for a basket detachably coupled to a shopping cart, the identifying data scanned from an optical machine-readable label affixed to the basket;
associating, at the server, the basket with a user profile corresponding to a client device;
determining, at the server, information identifying a vehicle associated with the user profile;
receiving, at the server, a checkout message indicating that a user of the client device has completed a purchase transaction and is requesting a drone for transporting the basket;
transmitting, in response to receiving the checkout message, the identifying data for the basket to a selected drone among a plurality of drones; and
transmitting instructions to the selected drone to carry the basket to the vehicle.

12. The method of claim 11, further comprising:
receiving and storing, at the server, a location of the vehicle determined by a GPS of the client device when the vehicle is parked in proximity to a retail store.

13. The method of claim 12, wherein the instructions transmitted to the selected drone causes the selected drone to locate the basket using the identifying data for the basket, and to carry the basket to the vehicle based on the location of the vehicle stored by the server.

14. The method of claim 13, further comprising:
processing an image included in the information identifying the vehicle; and
determining that the vehicle at the location matches the vehicle associated with the user profile based on the processing of the image.

15. The method of claim 11, wherein the information identifying the vehicle includes at least one of a license plate number, a make and a model of the vehicle, and a color of the vehicle.

16. The method of claim 11, wherein the basket includes an integrated scale to measure a total weight of the items in the basket, the integrated scale in communication with the server.

17. The method of claim 16, further comprising:
receiving at the server a total weight of the items in the basket,
comparing at the server the total weight with a predefined threshold, and
when the total weight is less than the predefined threshold, transmitting instructions from the server to an aerial drone as the selected drone, and
when the total weight is more than the predefined threshold, transmitting instructions from the server to a ground drone as the selected drone.

18. The method of claim 11, wherein the user profile includes a delivery preference, and the drone delivers the basket according to the delivery preference.

19. A non-transitory computer readable medium storing instructions that when executed by a processor causes the processor to implement a method for using a drone to transport items, the method comprising:
receiving, from the client device at a server, identifying data for a basket detachably coupled to a shopping cart, the identifying data scanned from an optical machine-readable label affixed to the basket;
associating, at the server, the basket with a user profile corresponding to a client device;
determining, at the server, information identifying a vehicle associated with the user profile;
receiving, at the server, a checkout message indicating that a user of the client device has completed a purchase transaction and is requesting a drone for transporting the basket;
transmitting, in response to receiving the checkout message, the identifying data for the basket to a selected drone among a plurality of drones; and
transmitting instructions to the selected drone to carry the basket to the vehicle.

20. The non-transitory computer readable medium of claim 19, wherein the instructions transmitted to the selected drone causes the selected drone to locate the basket based on the identifying data for the basket, and to carry the basket to the vehicle based on a location of the vehicle stored by the server.

21. The non-transitory computer readable medium of claim 19, wherein the instructions transmitted to the selected drone includes a code that enables the drone to automatically open a trunk of the vehicle.
